(19) United States
(12) Patent Application Publication
(10) Pub. No.: US 2023/0366074 A1
(43) Pub. Date: Nov. 16, 2023

(54) Oxygen Interception for Air Plasma Spray Processes

(71) Applicants: Andrei V. Ivanov, Indianapolis, IN (US); Daming Wang, Carmel, IN (US)

(72) Inventors: Andrei V. Ivanov, Indianapolis, IN (US); Daming Wang, Carmel, IN (US)

(21) Appl. No.: 18/316,473

(22) Filed: May 12, 2023

Related U.S. Application Data
(60) Provisional application No. 63/342,357, filed on May 16, 2022.

(51) Int. Cl. C23C 4/134; C23C 4/11

(52) U.S. Cl. CPC C23C 4/134; C23C 4/11

(57) ABSTRACT

The present invention generally relates to an atmospheric spray process for producing a controlled conical shrouded oxygen gas stream designed to intercept a plasma effluent stream to inject and mix oxygen with powder particles contained in the plasma effluent prior to the molten power particles entrained in the plasma effluent solidifying on a substrate.

### RELATED APPLICATIONS

This application claims the benefit of priority from U.S. Serial Application No. 63/342,357 filed on May 16, 2022, which is incorporated herein by reference in its entirety.

### FIELD OF THE INVENTION

The present invention generally relates to a thermal spray process for intercepting a plasma effluent with one or more conical shrouded oxygen gas streams that extends into the plasma effluent to inject and mix oxygen with powder particles contained in the plasma effluent prior to solidification of the powder particles onto a substrate to form a coating with improved properties.

### BACKGROUND OF THE INVENTION

Air plasma spraying (APS) involves applying material to a surface in an ambient atmosphere. APS systems typically include plasma torches, a powder feedstock supply and a substrate that is coated by deposition material derived from the powder feedstock supply. In APS systems, the plasma torch is exposed to ambient air and not contained within a vacuum or artificial atmosphere. As a result, APS systems are more easily to operate and implement into a manufacturing environment. For this reason, APS has become one of the most versatile and chosen methods for applying thermal spraying coatings. However, there are drawbacks of an APS process. For example, physical and/or mechanical properties of the coating produced with APS processes can be compromised.

In view of the drawbacks of conventional APS processes, there is an unmet need for an improved APS coating process that can improve the coating properties.

### SUMMARY OF THE INVENTION

The invention may include any of the following aspects in various combinations and may also include any other aspect of the present invention described below in the written description.

Other aspects, features and embodiments of the disclosure will be more fully apparent from the ensuing description and appended claims.

In a first aspect, a method of injecting oxygen into a plasma effluent during production of a coating, comprising: introducing one or more process gases into an air plasma spray torch to generate a plasma; introducing a flow of powder particles with a carrier gas into the plasma or in close proximity thereto to produce the plasma effluent, forming an oxygen gas stream; and intercepting the plasma effluent with the oxygen gas stream.

In a second aspect, a method of injecting oxygen into a plasma effluent during production of a coating, comprising: positioning an air plasma spray torch at a predetermined standoff distance, said predetermined standoff distance measured as an axial distance from a front surface of the air plasma spray torch to a substrate; introducing one or more process gases into the air plasma spray torch to generate a plasma; introducing a flow of powder particles with a carrier gas into the plasma or in close proximity thereto to produce a plasma effluent, forming a conical shrouded oxygen gas stream around a portion of plasma effluent; and intercepting the plasma effluent with the conical shrouded oxygen gas stream at an apex point of the conical shrouded oxygen gas stream.

In a third aspect, a method of injecting oxygen into a plasma effluent during production of a coating, comprising: positioning an air plasma spray torch at a predetermined standoff distance, said predetermined standoff distance measured as an axial distance from a front surface of the air plasma spray torch to a substrate; introducing one or more process gases into an air plasma spray torch to generate a plasma; introducing a flow of powder particles with a carrier gas into the plasma or in close proximity thereto to produce a plasma effluent; and forming multiple conical shrouded oxygen gas streams around a portion of the plasma effluent; wherein each of said multiple conical shrouded gas streams intercepts the plasma effluent at a corresponding interception point, said corresponding interception point located along a corresponding apex of each of said multiple conical shrouded oxygen gas streams.

### BRIEF DESCRIPTION OF THE DRAWINGS

The objectives and advantages of the invention will be better understood from the following detailed description of the preferred embodiments thereof in connection with the accompanying figures wherein like numbers denote same features throughout and wherein:

FIG. 1a shows a process schematic for intercepting a plasma effluent with a single conical shrouded oxygen gas stream at a first focal point, in accordance with the principles of the present invention;

FIG. 1b shows a cross-sectional view of FIG. 1a;

FIG. 2a shows an alternative process schematic of the present invention, in which 3 conical shrouded oxygen gas streams intercept a plasma effluent at 3 different focal points, respectively, along a central axis of the torch, in accordance with the principles of the present invention; and

FIG. 2b shows a cross-sectional view of FIG. 2a; and

FIG. 3 shows a bar graph comparing the degree of coating whiteness using the oxygen interceptor inventive process versus argon and nitrogen as interceptor gases and a baseline condition in which no interceptor gas is utilized.

### DETAILED DESCRIPTION OF THE INVENTION

The relationship and functioning of the various elements of the embodiments are better understood by the following detailed description. The detailed description contemplates the features, aspects and embodiments in various permutations and combinations, as being within the scope of the disclosure. The disclosure may therefore be specified as comprising, consisting or consisting essentially of, any of such combinations and permutations of these specific features, aspects and embodiments, or a selected one or ones thereof.

Where a range of values describes a parameter, all sub-ranges, point values and endpoints within that range or defining a range are explicitly disclosed herein. All physical property, dimension, and ratio ranges and sub-ranges (including point values and endpoints) between range end points for those properties, dimensions, and ratios are considered explicitly disclosed herein.

The drawings are for the purpose of illustrating the invention and are not intended to be drawn to scale. The embodiments are described with reference to the drawings in which similar elements are referred to by like numerals. Certain features may be intentionally omitted in each of the drawings to better illustrate various aspects of the novel process for intercepting a plasma effluent with one or more conical shrouded oxygen gas streams, in accordance with the principles of the present invention. The embodiments are described by way of example only, and the invention is not limited to the embodiments illustrated in the drawings.

The inventors have discovered that APS processes, upon generation of a plasma, can undergo a reduction in the oxygen content of the powder feedstock prior to deposition of the powder particles onto a substrate to form a resultant coating. In particular, when hydrogen is used in combination with other gases to generate the plasma, the inventors have observed that oxygen in the oxide powder particles can be reduced. Such reduction in oxygen content is undesirable, as it can cause the stoichiometric composition of the oxide particle to be depleted to the extent that the resultant coating properties are impacted and can fail to meet certain applicable coating part specifications. In particular, the inventors have discovered that properties of the deposited coating can be undesirably altered because of oxygen depletion in the powder feedstock during the coating process. The alteration in properties can be reflected by a darker color of the coating.

The present invention has emerged as a result of the failure of conventional APS processes to maintain oxygen content in the powder oxide feedstock. The present invention addresses the problem of oxygen deficiency that occurs when the powder feedstock is injected into the plasma effluent in its oxide form. In one aspect, the present invention allows control of oxide coating color and the creation of a desirable white color of the coating. The white coloration is indicative of minimal to no impact on several coating properties and coating performance.

As will be described, the present invention offers a modified and improved APS process that restores oxygen content of the powder feedstock, preferably to its original stochiometric content, thereby improving mechanical and/or physical properties of the resultant thermal spray coating that is produced.

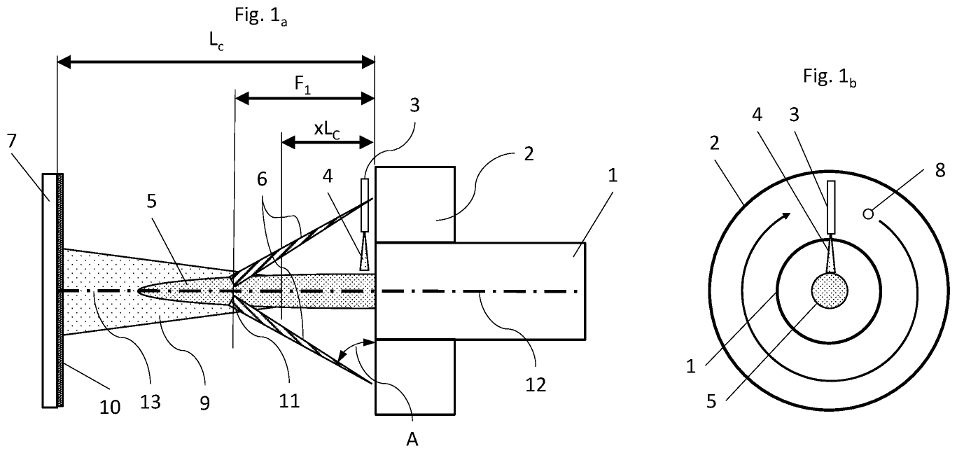

FIG. 1a shows a process schematic that is representative of one aspect of the present invention, which is referred to as an oxygen interceptor APS process 100. One or more process gasses (e.g., hydrogen, nitrogen, argon or any combination thereof) are introduced into air plasma spray torch 1 and thereafter into an arc chamber. An arc is struck between the cathode and anode. The one or more process gases pass through the arc to become superheated, thereby resulting in generation of a plasma. A powder feedstock 4 (e.g., ceramic oxide) in a presence of a suitable carrier gas (e.g., argon and/or nitrogen) is introduced through an external radial injector 3 into the plasma to produce a plasma effluent 5. The plasma effluent 5 is a combination of the plasma plume and the powder particles 4 that are entrained therein. A conical shrouded oxygen gas stream 6 is formed by introducing multiple oxygen streams through angled holes 8 of an oxygen interceptor unit 2. The holes 8 extend along on an edge of the front face (e.g., nozzle exit) of an oxygen interceptor unit 2, which is shown affixed to one end of the air plasma spray torch 1 in FIG. 1b. Each of the holes 8 is angled towards a plasma effluent axis 13 having an angle A. Angle A is defined relative to a surface that is perpendicular to a front surface of the air plasma spray torch 1. The oxygen streams emerge from the angled holes 8 to produce the conical shrouded oxygen gas stream 6 characterized by the angle A as shown in FIG. 1a. FIG. 1a shows that the conical shrouded oxygen gas stream 6 surrounds a portion of the plasma effluent 5 from the exit of the torch 1 to the interception location 11. Interception location 11 represents where the conical shrouded oxygen gas stream 6 intercepts the plasma effluent 5 at or within the vicinity of a plasma effluent axis 13. The interception location 11 is where the oxygen streams converge to form the apex or conical tip of the conical shrouded oxygen gas stream 6, and can typically represent the region of most intense oxygen penetration into the plasma effluent 5 provided by a particular conical shrouded oxygen gas stream 6. The plasma effluent axis 13 as shown in FIG. 1a is substantially coincident with a central axis of the air plasma spray torch (i.e., torch centerline 12).

The lateral or axial distance from the nozzle face of the torch 1 at which interception occurs is a focal point, which is designated as f1 in FIG. 1a. The focal point f1 may take on any reasonable value that is located between the substrate 7 and nozzle exit or front face of the oxygen interceptor unit 2. For example, the focal point f1 can range from 0-250 mm. Alternatively, the focal point is equal to or greater than x*Lc where Lc is the coating application distance as shown in FIG. 1a, and x represents a fractional portion of the overall coating application distance Lc that ranges from 0 to 1. In another embodiment, x varies from 0.3 to 0.7 such that the focal point can take on any value with a range of 0.3*Lc-0.7*Lc, as measured from a nozzle face of the oxygen interceptor unit 2. In another embodiment, the focal point f1 is situated along a central axis 12 of the torch 1 that is from about 3 to about 20 times of internal diameters of the nozzle of the air plasma spray torch 1. Accordingly, the conical shrouded oxygen gas stream 6 as shown in the process of FIG. 1a can be tuned, at least in part, by selection of the angle A and the focal point f1.

The conical shrouded oxygen gas stream 6 converges at the point of interception 11 to form a conical-based geometry. The oxygen shrouded gas stream 6 is configured to inject and mix oxygen with the powder particles 4 of the plasma effluent 5 at any location or all locations where the shrouded gas stream 6 is in contact with the plasma effluent 5. Oxygen impingement occurs at a maximum at the point of interception 11. The oxygen at the interception 11 becomes entrained with the plasma effluent 5 and the oxygen and the plasma effluent 5 are directed along the plasma effluent axis 13 towards the substrate 7, where the powder particles 4 are deposited onto the substrate 7 to form the coating 10. The powder particles 4 interact with oxygen during flight towards the substrate 7 and prior to solidification of the powder particles onto the substrate 7.

The inventors have determined the criticality of oxygen injection and mixing during powder particles being in-flight towards the substrate. Reaction of oxygen with the powder particles in this case is governed by the phenomenon of diffusion. The diffusion process is dependent on temperature and free path between molecules. While the powder particle material is in-flight, it is semi and/or fully molten and the oxygen diffusion is technically feasible. However, when the powder particles touch the substrate surface, they rapidly solidify. Diffusion coefficient in liquids is on the order of 10-9 m²/s, whereas in solids it is 10-10 to 10-14 m²/s. Consequently, it is not feasible to adjust oxygen content uniformly through coating thickness after the coating is formed unless the entire part or substrate can be heated in the oxygen-rich atmosphere. This could be done for a rare number of applications, where the part material can withstand oxidation and elevated temperature conditions. By using the oxygen interceptor process of the present invention, the desired oxidation happens in a controlled and tunable manner before coating formation, no extra operation is necessary, and limitations imposed by part material become irrelevant.

FIG. 1b shows a cross-sectional view of the air plasma torch 1 and oxygen interceptor unit 2 of FIG. 1a, which reveals the multiple holes 8 situated on a front section of the oxygen interceptor unit 2 and arranged in a circular pattern that is substantially concentric to the torch 1 centerline 12. Each of the holes 8 as mentioned hereinabove are configured at an angle A towards a centerline of the plasma effluent axis 13 to enable each of the oxygen streams that are fed through the holes 8 to converge with each other downstream at the interception point 11. The oxygen flow in the aggregate from each of the holes 8 may range in value from about 10 vol % to about 200 vol % of the flow of plasma effluent 5. The exact flow of oxygen required to produce the shrouded oxygen gas stream 6 with desired efficacy may depend on several variables, including, but not limited to, the degree of oxygen injection and mixing required as the molten powder particles 4 are in-flight with the plasma effluent 5; the overall coating application distance Lc; and the focal point f1. FIG. 1b shows that the plasma effluent 5 is created within the torch 1 along its centerline 12 and thereafter emerges from within the torch 1 to commingle with the injected powder particles 4 and produce the plasma effluent 5 which travels along the plasma effluent axis 13. A single, substantially symmetrical oxygen shrouded gas stream 6 interacts with the plasma effluent at the focal point f1 to begin the process of injection and mixing of oxygen with the powder particles 4 entrained within plasma effluent 5. The oxygen mixes with and interacts with plasma effluent 5 in the region 9 to sufficiently mix oxygen with the semi-molten and/or fully molten powder particles before coating 10 is formed on substrate 7.

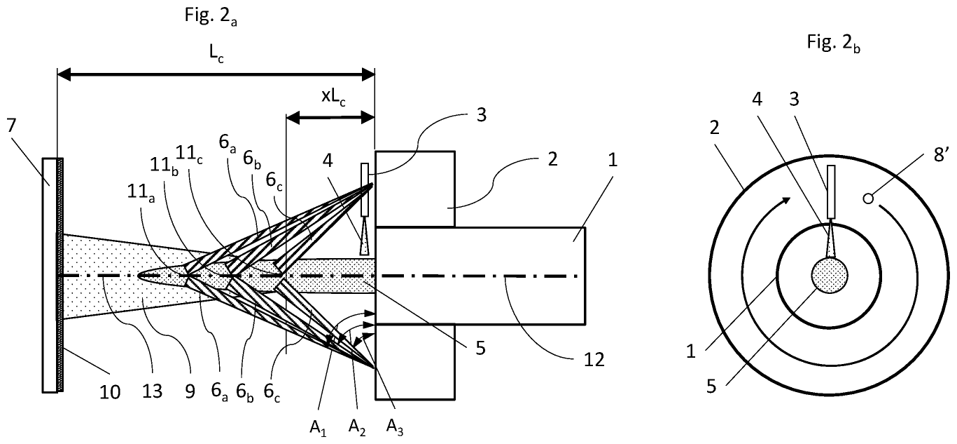

FIGS. 2a and 2b show an alternative embodiment of the present invention, in which multiple oxygen conical shrouded gas streams can be utilized to create more points of oxygen interception. By way of example and not intending to be limiting, FIG. 2a shows 3 shrouded oxygen gas streams 6a, 6b and 6c, each of which intercepts the plasma effluent axis 13 at an intersection point 11a, 11b and 11c, respectively. Each interception point 11a, 11b and 11c represents the apex or tip of the conical-shaped geometry of the corresponding shrouded oxygen gas stream 6a, 6b and 6c. The shrouded oxygen gas streams 6a, 6b and 6c are produced from the specific configuration of holes 8′ shown in FIG. 2b. The holes 8′ are arranged in a circular pattern that is substantially concentric to the torch 1. However, unlike the arrangement of holes 8 in FIG. 1b, the holes 8′ in FIG. 2b are modified to be arranged at different angles of A1, A2 and A3 towards plasma effluent axis 13 to enable the individual oxygen streams that are fed therethrough to create intersection points 11a, 11b and 11c and facilitate incorporation of oxygen into the plasma effluent 5 over a larger interaction or contact zone. The injected oxygen therefore is distributed over a larger zone. Angles A1, A2 and A3 are defined relative to a surface that is perpendicular to a front surface of the air plasma spray torch 1. Intersection point 11a is defined by angle A1 and a first focal point. Intersection point 11b is defined by angle A2 less than angle A1 and a second focal point less than the first focal point. Intersection point 11c is defined by angle A3 less than angle A2 and a third focal point less than the second focal point. It should be noted that the first focal point, second focal point and third focal point, while not labelled in FIG. 2a, have the same meaning as mentioned with respect to FIG. 1a, and represent the lateral or axial distance from the front face of the oxygen interceptor unit 2 to the point of intersection 11a, 11b, and 11c, respectively (similar to that shown for f1 in FIG. 1a). Each of shrouds 6a, 6b and 6c have a conical-shaped geometry. FIG. 2a shows that shroud 6a is the outermost shroud and overlaps shrouds 6b and 6a. Shroud 6b is an intermediate shroud that overlaps innermost shroud 6a. The innermost shroud 6a intercepts the plasma effluent 5 at a focal point having a distance equal to x*Lc, which represents the minimum axial distance required for oxygen interception to occur. Forming an overlapping configuration may allow for additional oxygen injection and mixing with the molten powder particles 4 entrained within the plasma effluent 5 relative to that shown in FIG. 1a by virtue of enhancing oxygen distribution along a greater portion of the plasma effluent 5 while also increasing the concentration of oxygen that penetrates into the plasma effluent 5 per unit volume of the plasma effluent 5. The shrouds 6a, 6b and 6c are preferably symmetrical about the plasma effluent axis 13, which is substantially coincident with a centerline 12 of the air plasma spray torch 1, thereby optimizing the process for oxygen injection and mixing.

It should be understood that any number of shrouds can be formed with the present invention. In one example, 2 shrouded oxygen gas streams are formed. In another example, more than 3 oxygen shrouded streams are formed.

Other suitable ways for creating the multiple conical shrouded streams are contemplated by the present invention. For example, instead of creating the 3 shrouds of FIG. 2a using the holes 8 configured in a single concentric pattern along the front face of the oxygen interceptor 2 as shown in FIG. 2b, 3 separate groups of holes can be utilized, namely (i) an outer ring of holes along the front face of the oxygen interceptor unit 2 to create the outermost shroud 6a, (ii) a middle ring of holes along the front face of the oxygen interceptor unit 2 to create the intermediate shroud 6b and (iii) an inner ring of holes along the front face of the oxygen interceptor unit 2 to create the innermost shroud 6c. Furthermore, certain groups of the holes can be turned on/off by choosing specific groups of holes to flow oxygen therethrough, thereby permitting control over the length and location of the intersection point along the plasma effluent axis 13.

Still further, in an alternative design, the oxygen interceptor unit 2 may have a circular slot instead of multiple, discrete holes 8 at a single angle for feeding oxygen. The slot extends periphery around the face of the oxygen interceptor unit 2. The slot is sized to allow a predetermined amount of oxygen to flow therethrough to create a shrouded oxygen gas stream having the desired efficacy upon reaching its predetermined intersection point. In other words, the more intensity with which the plasma effluent 5 can be surrounded with oxygen, the more oxygen injection and mixing that can be achieved.

Although the embodiments have disclosed external radial injection for the powder feedstock particles 4, it should be understood that any suitable injection configuration is contemplated. For example, the injection can occur internally within torch 1 in a radial direction (i.e., perpendicular to the torch centerline 12) or axially along a backend of the torch 1 (i.e., parallel to the torch centerline 12).

Still further, it should be understood that certain applications may not require formation of a shrouded oxygen gas stream having a first angle relative to a surface that is perpendicular to the air plasma spray torch. Instead, the oxygen may intercept the plasma effluent from an external source separate from the torch 1 that is at a predetermined location along the plasma effluent. For example, oxygen may be fed through an external lance that is oriented perpendicular to the plasma effluent 5 to pinpoint oxygen into the plasma effluent 5 rather than envelope the plasma effluent with an oxygen shrouded gas stream.

Still further, an alternative process of the present invention contemplates forming multiple oxygen shrouds in which at least one of the oxygen shrouds does not intercept the plasma effluent 5. For example, 2 oxygen shrouded gas streams intercept a plasma effluent stream at 2 different focal points, respectively along a central axis of the plasma torch, and a third oxygen shrouded gas stream converges at a third location beyond the substrate without intercepting the plasma effluent at a focal point. In this manner, the present invention offers flexibility in controlling the amount of oxygen injection and mixing required via the shroud contacting the plasma effluent 5 along the coating application distance Lc and the intersection point which causes optimal oxygen intermixing in a concentrated manner.

Other variations to the present invention are possible. For example, other non-oxygen gases can serve as dilution to control the amount of oxygen delivered while simultaneously performing a critical so-called “transport” function. For example, if the required amount of oxygen required for injection and mixing is relatively low, then the strength of the individual oxygen streams may decay before reaching the plasma plume, thereby reducing the efficacy of the oxygen shrouded gas streams. To compensate for this oxygen decay, the addition of nitrogen can be incorporated into the shroud to increase the total gas velocity, thereby mitigating the adverse effects of oxygen decay and allow oxygen to reach plasma plume in an effective more concentrated manner to create the necessary oxygen injection and mixing with the powder particles 4 entrained into the plasma effluent 5 while the particles 4 remain in-flight.

Still further, the present invention is not limited to use with oxide materials. For example, the processes described hereinabove may be implemented with other coating materials to form metallic oxides during the coating process, thereby forming in-situ metallic oxides from a particular powder feedstock prior to the metallic oxides depositing onto a substrate and forming a resultant coating. The amount of oxides which are produced can be controlled by the principles of the present invention as has been described hereinabove.

It is quite evident that the present invention represents a notable departure from typical shrouded processes. Prior to the emergence of the present invention, shrouded processes were designed to protect and insulate the plasma effluent from external atmospheric gases to ensure the plasma effluent retained heat and remained unaltered and did not undergo oxidation. On the contrary, the present invention seeks to intentionally create an oxygen shroud that intercepts and interacts with the plasma effluent to control and adjust oxide content of powder particles during flight. The oxygen interceptor processes of the present invention intentionally intercepts with the plasma plume and particles (i.e., collectively plasma effluent) to add oxygen and increase turbulence to enrich the plasma effluent with oxygen and promote its diffusion into the molten particles before they form a coating. The injection and mixing of oxygen to control and adjust oxygen content of the fully molten and/or semi-molten powder particles occurs without combustion; the present invention is not utilizing a combustion oxygen shroud in which heat of combustion is utilized to impart heat energy into the plasma effluent.

As will be shown and discussed below in the Working Examples, experiments were performed to compare coating properties created by the present invention with other coating processes. Interceptor functional tests were carried out. An interceptor function test with oxygen flow in accordance with the present invention was performed. Another interceptor test utilized argon instead of oxygen. Another interceptor test utilized nitrogen instead of oxygen. A baseline test was also performed in which no oxygen was utilized. During all carried out tests, oxygen interceptor unit 2 as shown in the design according to FIG. 1a, 1b was used to create a conical shrouded interceptor gas stream 6 formed by introducing multiple test gas streams through angled holes 8 of the oxygen interceptor unit 2. The oxygen interceptor unit was mounted on an air plasma torch during all tests. The tests revealed that only the presence of gas flow and the type of gas determined the coating properties.

### COMPARATIVE EXAMPLE 1 (Baseline Condition)

A baseline condition that did not utilize oxygen was carried out as follows. A set of three substrates (all of which had a diameter of 14 inches) was situated in front of the air plasma torch on a rotating fixture at standoff distances (designated as L_{c} in FIG. 1a) of 4.5 inches, 5.5 inches and 6.5 inches away from the torch face, respectively. Corresponding diameters for the rotating fixture were 16, 14 and 12 inches, respectively.

A plasma plume was generated from argon and hydrogen. Torch argon flow was 212 SCFH; hydrogen flow was 20.4 SCFH; and the plasma arc current was set at 600 amperes. The torch was held and manipulated by a robotic arm such that the torch angle to the substrate surface was maintained at 90 degrees, as shown in FIG. 1a. The torch axis traversed sufficiently past the substrates in a vertical direction to ensure that the complete surface of substrates was subjected to the plasma. Rotation of the fixture and the traverse speed of the robotic arm were set such that the surface speed of the substrate at 14 inches diameter was 1800 inches per minute and advancement of the torch per revolution of the fixture was 0.25 inches. After completing 2 passes over the substrates, the preheat portion of the process was completed.

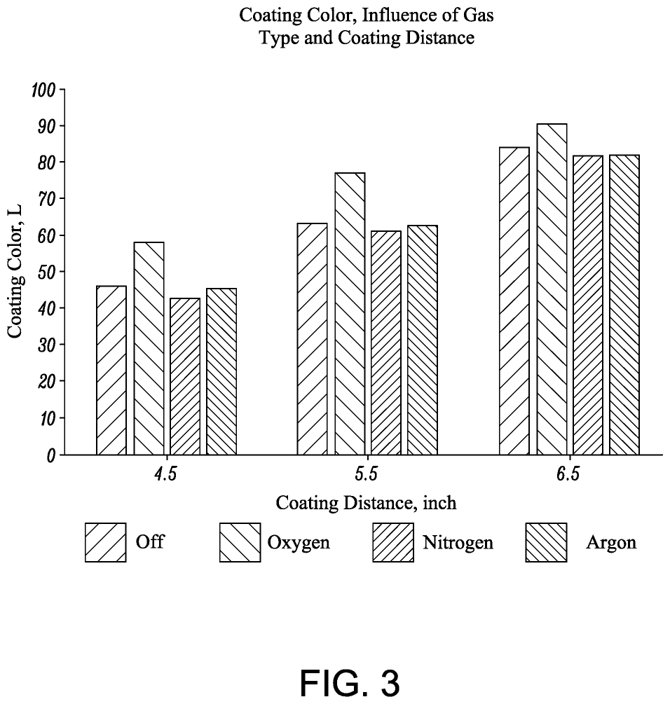

Next, the torch was positioned away from substrates by the designated standoff distances L_{c} of 4.5 inches, 5.5 inches and 6.5 inches, respectively. Powder feedstock was introduced into the plasma plume using argon carrier gas. The argon carrier gas flow was set at 8 SCFH; and the powder feed rate was set at 50 grams per minute. After desired powder feed rate was achieved, torch manipulation continued over each of the 3 substrates for another 16 passes during which the coating was formed on the substrates. The coating process was finished after completion of passes and substrates were allowed to cool naturally to room temperature before handling. The coating results for this baseline test are shown in FIG. 3 as the bar designated as “Off.” This baseline test condition of having no gas flow through the oxygen interceptor unit served as a reference point for evaluating degree of oxygen depletion for the other tests. Degree of oxygen depletion is a key coating characteristic observed and was measured on the test substrates. The degree of oxygen replenishment was correlated by quantifying the degree of lightness or whiteness in which more lightness of the coating was evidence of greater oxygen replenishment into the coating. The degree of lightness was quantified by a color measurement device that was designed to characterize degree of lightness according to a CIELAB color space, which is also known as L*a*b scale, to obtain a numerical value of lightness L*, where 0 represents perfect black and 100 represents perfect white. The results of the measurements are summarized in FIG. 3, with the value of the Coating Color, L (i.e., degree of whiteness) shown along the y-axis.

### COMPARATIVE EXAMPLE 2 (Argon)

A second test employing argon as the interceptor gas was performed. A set of three substrates was situated in front of the plasma torch on a rotating fixture at standoff distances (designated as L_{c} in FIG. 1a) of 4.5 inches, 5.5 inches and 6.5 inches away from the torch face, respectively. Corresponding diameters for the rotating fixture were 16, 14 and 12 inches, respectively.

Argon flow through the interceptor was set to 113 SCFH. All other test conditions and operational procedures were identical to that described in Comparative Example 1.

Process performance was based on the degree of coating whiteness, L as shown in FIG. 3, whereby a higher degree of whiteness is indicative of certain favorable coating properties. The coating results for this test are shown in FIG. 3 as the bar designated “Argon” and indicates that the Argon interceptor gas performed on-par or even slightly worse than the baseline condition of Comparative Example 1 in which no intercepting gas was utilized. In other words, the degree of whiteness for these tests were on-par or slightly less white compared to the baseline condition.

### COMPARATIVE EXAMPLE 3 (Nitrogen)

A third test employing nitrogen as the interceptor gas was performed. A set of three substrates was situated in front of the plasma torch on a rotating fixture at standoff distances (designated as Lc in FIG. 1a) of 4.5 inches, 5.5 inches and 6.5 inches away from the torch face, respectively. Corresponding diameters for the rotating fixture were 16, 14 and 12 inches, respectively.

Nitrogen flow through the interceptor was set to 135 SCFH. All other test conditions and operational procedures were identical to that described in Comparative Examples 1 and 2.

Process performance was based on the degree of coating whiteness, L as shown in FIG. 3, whereby a higher degree of whiteness is indicative of certain favorable coating properties. The coating results for this test are shown in FIG. 3 as the bar designated “Nitrogen” and indicates that the Nitrogen interceptor gas performed slightly worse than the baseline condition of Comparative Example 1 in which no intercepting gas was utilized; and the Argon interceptor gas of Comparative Example 2. In other words, the degree of whiteness for these tests were slightly less compared to those coatings produced in Comparative Examples 1 and 2.

### EXAMPLE 1 (Present Invention—Oxygen)

A fourth test employing oxygen as the interceptor gas was performed in accordance with the present invention. A set of three substrates was situated in front of the plasma torch on a rotating fixture at standoff distances (designated as Lc in FIG. 1a) of 4.5 inches, 5.5 inches and 6.5 inches away from the torch face, respectively. Corresponding diameters for the rotating fixture were 16, 14 and 12 inches, respectively.

Oxygen flow through the interceptor was set to 125 SCFH. All other test conditions and operational procedures were identical to that described in Comparative Examples 1 and 2.

Process performance was based on the degree of coating whiteness, L as shown in FIG. 3, whereby a higher degree of whiteness is indicative of certain favorable coating properties. The coating results for this test are shown in FIG. 3 as the bar designated “Oxygen” and indicates that the Oxygen interceptor gas performed the best. In other words, the degree of whiteness for these tests were highest compared to those coatings produced in Comparative Examples 1, 2 and 3. The higher bar indicates a higher coating color value, L, which is indicative of a higher degree of whiteness. It is evident, that flow of oxygen through interceptor device significantly affected oxygen depletion of the coating by elevating oxygen content in the coating to a higher amount than the benchmark condition of using no oxygen. Use of inert gases such as argon or nitrogen instead of oxygen had no meaningful effect of increasing oxygen content in the coating, as evident by the degree of whiteness as measured on the y-axis of the bar graph.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

1. A method of injecting oxygen into a plasma effluent during production of a coating, comprising:
introducing one or more process gases into an air plasma spray torch to generate a plasma;
introducing a flow of powder particles with a carrier gas into the plasma or in close proximity thereto to produce the plasma effluent,
forming an oxygen gas stream; and
intercepting the plasma effluent with the oxygen gas stream.

2. The method of claim 1, further comprising:
flowing the plasma effluent with the powder particles and oxygen entrained therein towards the substrate; and
depositing the powder particles onto the substrate to form the coating.

3. The method of claim 1, wherein the oxygen gas stream is introduced at an oxygen flow rate that ranges from about 10 vol % to about 200 vol % relative to a plasma effluent gas flow rate.

4. The method of claim 1, wherein the intercepting occurs at a focal point that is situated along a central axis of the torch and that is from about 3 to about 20 times of internal diameters of the nozzle of the air plasma spray torch.

5. The method of claim 1, further comprising feeding a non-oxygen gas into the oxygen gas stream to increase a velocity of the oxygen gas stream.

6. The method of claim 1, further comprising the oxygen gas stream interacting with the powder particles to replenish oxygen content into the powder particles.

7. The method of claim 1, further comprising the oxygen gas stream interacting with the powder particles in-situ to form a metallic oxide.

8. A method of injecting oxygen into a plasma effluent during production of a coating, comprising:
positioning an air plasma spray torch at a predetermined standoff distance, said predetermined standoff distance measured as an axial distance from a front surface of the air plasma spray torch to a substrate;
introducing one or more process gases into the air plasma spray torch to generate a plasma;
introducing a flow of powder particles with a carrier gas into the plasma or in close proximity thereto to produce a plasma effluent,
forming a conical shrouded oxygen gas stream around a portion of plasma effluent; and
intercepting the plasma effluent with the conical shrouded oxygen gas stream at an apex point of the conical shrouded gas stream.

9. The method of claim 8, wherein the step of intercepting the plasma effluent with the conical shrouded oxygen gas stream occurs at a focal point, said focal point measured as an axial distance from a front surface of the air plasma spray torch to the apex point of the conical shrouded gas stream.

10. The method of claim 9, wherein the focal point has a value that ranges from about 30% to about 70% of the predetermined standoff distance of the air plasma torch.

11. The method of claim 9, wherein the apex is substantially along a central axis of the air plasma torch.

12. A method of injecting oxygen into a plasma effluent during production of a coating, comprising:
positioning an air plasma spray torch at a predetermined standoff distance, said predetermined standoff distance measured as an axial distance from a front surface of the air plasma spray torch to a substrate;
introducing one or more process gases into an air plasma spray torch to generate a plasma;
introducing a flow of powder particles with a carrier gas into the plasma or in close proximity thereto to produce a plasma effluent; and
forming multiple conical shrouded oxygen gas streams around a portion of the plasma effluent;
wherein each of said multiple conical shrouded gas streams intercepts the plasma effluent at a corresponding interception point, said corresponding interception point located along a corresponding apex of each of said multiple conical shrouded oxygen gas streams.

13. The method of claim 12, wherein each of said multiple shrouded oxygen gas streams is defined by a corresponding angle relative to a surface that is perpendicular to a front surface of the air plasma spray torch and a corresponding focal point measured as an axial distance from the front surface of the air plasma spray torch to an apex point of one of the multiple shrouded gas streams.

14. The method of claim 12, further comprising the step of:
flowing the plasma effluent with the powder particles and oxygen entrained therein towards the substrate; and
depositing the powder particles onto the substrate to form the coating.

15. The method of claim 12, wherein the plasma effluent is substantially coincident with a central axis of the air plasma spray torch, and further wherein said corresponding apex of each of said multiple conical shrouded oxygen gas streams is substantially coincident with the central axis.
